(19) United States
(12) Patent Application Publication
(10) Pub. No.: US 2019/0149348 A1
(43) Pub. Date: May 16, 2019

(54) Recording System with Personal Keys for Personal Meetings with Service Providers

(71) Applicants: Eliahu Antopolsky, Zichron Yaakov (IL); Yacov Gottman, Karkur (IL)

(72) Inventors: Eliahu Antopolsky, Zichron Yaakov (IL); Yacov Gottman, Karkur (IL)

(21) Appl. No.: 15/813,180

(22) Filed: Nov. 15, 2017

(51) Int. Cl. H04L 12/18; H04N 5/907; G06F 21/32

(52) U.S. Cl. CPC H04L 12/1831; G06F 21/32; H04N 5/907; H04L 12/1822

(57) ABSTRACT

A recording system for personal meetings between two or more participants that includes a voice recording means, a camera, a memory means, and an identification sub-system. The identification sub-system is designed to identify a personal key of each participant of the personal meeting. The personal keys may be a code, a digital code, an electronic card, a biometric feature, voice or face recognition, a finger print, a retina and the like. When activating the recording system the identification sub-system is designed to identify personal keys of the participants of that specific personal meeting. The recording is stored in the memory means and the access to the recording can be done only by using the personal keys of the participants of that personal meeting.

### FIELD OF THE INVENTION

The present invention relates to a recording system for face to face personal meetings that enables access to the recording files only by personal keys of the participants of that personal meeting, and that may be served by a service provider for many of his or her clients or patients.

### BACKGROUND OF THE INVENTION

In many cases disputes arise as to the nature and the content of meetings that were held in the past, mainly when such meetings were not recorded and were between two persons in private. Experience of life teaches us that in many such cases one participant alleges ex post facto that during the meeting certain events have happened or certain spoken words have been told and on the other hand the other participant alleged differently. Systems for meeting documentation which include audio and video recording are known in the art and can provide satisfactory solution in a wide range of cases. However, such a solution is not sufficient in special cases, when the participants have interest to record the meeting and in the same time they are also interested in the safety of documentation, in the meaning that no one—even one of the participant—would have an access to the documentation without specific consent of all the participant of that meeting.

Such kind of meetings can be for example: meetings between psychologist or psychiatric and patient in which the patient discloses personal and intimate information that he or she does not want that this information would be disclosed to others; meetings between attorney and his client when they discuss sensitive matters; meetings for medical treatment such as dental, physiotherapy and other kinds of medical treatment; The expression “personal meeting” or “face to face personal meeting” in this patent application and in the claims relates to all of those kind of meetings, which express meetings in which the participants are together in the same place and time.

There are many sound and video recording devices that are not, however, equipped with any components that prevent unauthorized access to the documentation. The present invention offers a solution for people, mainly service providers, for example therapists, doctors, lawyers and the like who wish to record their personal meeting with their clients in a way that will prevent any access to the recording unless such access is authorized by all of the meeting's participants and by the positive action of each and every one of the participants, and also that this recording system may be used by these service providers with many patients, clients and the like.

### LIST OF DRAWINGS

The intention of the drawings attached to the application is not to limit the scope of the invention and its application. The drawings are intended only to illustrate the invention and they constitute only one of its many possible implementations.

FIG. 1 describes schematically the recording system (1), the voice recording means (2), the camera (3), the memory means (4), the identification sub-system (5), the microprocessor (6) and the computer program (7).

### THE INVENTION

The main object of the present invention is to provide a recording system (1) for face to face personal meetings between two persons or more, that enables access to the recording of each personal meeting only by using each personal key of each participant of that specific meeting and that it is possible to use this recording system (1) for many meetings in different occasions and with different participants, including by a service provider with many patients, clients and the like.

The recording system (1) includes a voice recording means (2), a camera (3), a memory means (4), an identification sub-system (5), and a microprocessor (6) with computer program (7). The microprocessor (6) may serve also as the memory means (4) of the recording system (1); in the claim we mention these two components separately, but the interpretation of the claim is that it is possible that one microprocessor may serve as the microprocessor (6) and the memory means (4).

The identification sub-system (5) is designed to identify the personal key of each participant and this personal key may be a signature, a code or digital code for example a digital code that may be processed by a smartphone, a magnetic or an electronic card, a biometric feature, face recognition, voice recognition, a finger print, a retina and other kind of personal means or features which are unique to a person. It is possible that the identification sub-system (5) includes a personal key reader (51) for identifying the personal keys in each kind of implementation of the invention. For example, the personal key reader (51) may be a keyboard for tapping a code, a voice recognition means, a face recognition means, a finger print means, a retina recognition means, a reader for electronic cards and the like.

When activating the recording system (1) for recording a face to face personal meeting, the recording is done by the voice recording means (2) and the camera (3). The identification sub-system (5) is designed to identify the personal keys of the participants of every specific face to face personal meeting. It is possible for example that before starting the recording the participants tap codes or put their fingers on the personal key reader (51) and the computer program (7) in the microprocessor (6) locks the recording. It is clear from the above explanation that each participant possesses his own personal key and also that the computer program (7) is designed to unlock the recordings, which is saved in the memory means, and by that to enable an access to a specific recording of a specific face to face personal meeting by using same personal keys of the participants of that specific face to face personal meeting.

The term “lock” in this application and in the claims means that the recording is encrypted or scrambled or undergoing a process that makes it impossible to open it and to have an access to its content and to view it, but only by using these specific personal keys of these participants of this specific face to face personal meeting. The term “unlocked” in this application and the claims means that the recording file can be opened and viewed.

The recording of the specific face to face personal meeting is stored in the memory means (4). The unlocking and the access to the recording of the specific face to face personal meeting can be done only by using the personal keys of the participants of that specific face to face personal meeting.

It is clear from the above explanation that unlocking and the access to each specific recording can be done only by consent of all of the specific participants of that specific face to face personal meeting, by using all of their personal keys. Each participant of that specific face to face personal meeting is aware of the fact that the recording is locked and inaccessible to any person without his or her consent and without using his or her personal key. It is possible to use the recording system for recording face to face personal meetings in different occasions and with different participants whereby each specific recording of specific personal meeting is locked by the computer program (7) and can be unlocked only by using the personal keys of the participants of that specific personal meeting. In this way, a service provider, a psychologist for example, can have one recording system (1) and he can use it for his meetings with different patients and in each specific meeting he and the specific patient can use their personal keys and any access to this specific recording can be done with their own personal keys, regardless the fact that the memory means (4) includes other recordings of other personal meetings with other persons.

The voice recording means (2) includes a microphone and it can be any kind of a standard recording voice means which enables voice recording and storing this recording in a memory means. The camera (3) can be any kind of a standard video recording means which enables video recording and storing this recording in a memory means. The memory means (4) can be any kind of a microprocessor or any kind of storing means that are known in which the recording of the personal meeting are stored. The structure of voice recording means, the camera and the memory means and the way they are connected to each other are understandable to any average expert in the field and therefore there is no need for further details. The recording system (1) may also include an internal power source or connection to an electrical network.

The way of using the recording system (1): anyone who plans to have a personal meeting, or series of such meetings, can purchase the recording system (1) and can use it for recording those meetings. Any participant gets an authorized key, and therefore only the participants together and with their own consent may have access to the recording of their personal meeting. If after a personal meeting one of the participants alleged that during the meeting something wrong had happened, or in any other case of disagreeing as to the nature of the meeting, the participants can together open the file of the recording, and by that to resolve the dispute. It is clearly understood that if the keeper of the recording system destroyed or lost it then this fact would be held against him in any legal or other proceedings.

The recording system (1) can be used to record one or series of personal meetings between the same participants, or between one service provider with many of his clients or patients. The recording system (1) provides an inexpensive and efficient solution for recording such face to face personal meetings.

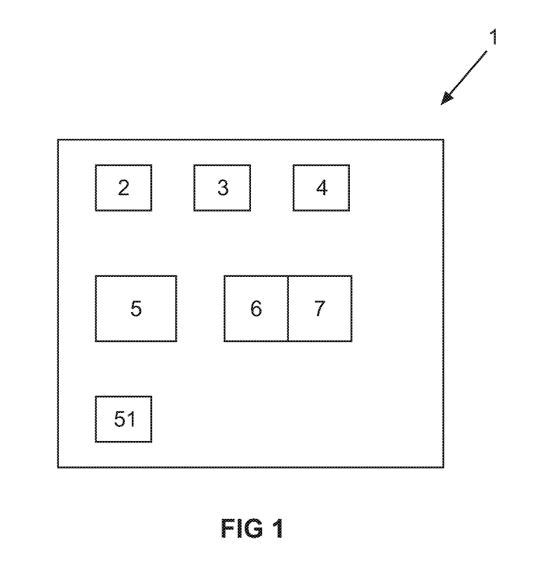

FIG. 1 describes schematically the recording system (1) that includes a voice recording means (2), a camera (3), a memory means (4), an identification sub-system (5), microprocessor (6) and a computer program (7).

What is claimed is:

1. A recording system for face to face personal meetings between two or more participants, comprising: a voice recording means, a camera, a memory means, an identification sub-system, and a microprocessor with a computer program;
wherein said recording system is designed to make recordings of said face to face personal meetings by the voice recording means and the camera and to save said recordings in the memory means; wherein said identification sub-system is designed to identify personal keys of said participants of said face to face personal meetings; wherein the computer program is designed to lock said recordings and by that to disable access to said recordings, and to unlock said recordings and by that to enable access to said recordings by using personal keys of the participants; wherein uncloaking and an access to a specific recording of a specific face to face personal meeting can be done only by using personal keys of participants of said specific face to face personal meeting;
whereby said uncloaking and access to said specific recording can be done only by consent of all of said participants of said specific face to face personal meeting by using all of their personal keys; whereby each participant of said specific face to face personal meeting is aware of the fact that said specific recording is inaccessible to any person without his or her consent and without using his or her personal key; and whereby enabling to use said recording system for recording face to face personal meetings in different occasions and with different participants and to save said recordings in said memory means; and whereby each of said specific recording can be accessible only by personal keys of the participants of said specific face to face personal meeting.
